(19) United States
(12) Patent Application Publication
(10) Pub. No.: US 2002/0091855 A1
(43) Pub. Date: Jul. 11, 2002

(54) Method and apparatus for dynamically addressing and routing in a data network

(76) Inventors: Yechiam Yemini, Edgewater, NJ (US); Michael D. Grossberg, New York, NY (US); Danilo Florissi, Briarcliff Manor, NY (US)

Correspondence Address: Proskauer Rose LLP, Patent Department, 1585 Broadway, New York, NY, 10036, US

(21) Appl. No.: 09/775,350

(22) Filed: Feb. 1, 2001

Related U.S. Application Data
(60) Provisional application No. 60/179,884, filed on Feb. 2, 2000.
(60) Provisional application No. 60/216,403, filed on Jul. 6, 2000.

(51) Int. Cl. G06F 15/173

(52) U.S. Cl. 709/238

(57) ABSTRACT

DART dynamically assigns addresses to Nodes according to their relative location within the network. When a Node joins or moves the network, or a Link or Node fails addresses are dynamically updated. If some Nodes are mobile (either clients or servers) the ability to route to and from the mobile Node persists. Link failures, caused by movement, or otherwise, can be similarly accommodated.

### FIELD OF THE INVENTION

The present invention relates to a method and apparatus for addressing sources and destinations of information in a physical data network and related processes. This network is comprised of Nodes interconnected by Links. The Links may use any physical means by which to transport data from one location to another, such as electronic, optical or radio transmissions.

### BACKGROUND OF THE INVENTION

Typically a physical or virtual network is comprised of units capable of performing some operation on signal or data streams. We call these units Nodes, and connections between these Nodes we call Links. In order for data to travel from a source Node to one or more destination Node(s), some arrangement must be made for this data to be properly directed from Node to Node via Links that will allow the data to arrive properly at the destination Node. Both source and destination Nodes have at least one identifier, which identifies the Nodes. For example, these identifiers could be URLs such as http://www.cs.columbia.edu/home/index.html in the Internet. In order for data to travel from one Node to another, addresses are bound, either permanently or temporarily, to these identifiers. These addresses are then used by whatever routing mechanism is employed to determine the path of Links that the data should take as the data travels from source Node to destination Node.

Addressing mechanisms, such as MAC numbers in Ethernet, IP addresses in the Internet, or tags in MPLS, are used with their accompanying routing mechanisms to direct streams of data to their destinations. Currently most of these mechanisms are either not flexible enough or not scaleable and therefore must be used in combination, resulting in complex, multi-layer networks. This creates problems of performance, configuration, compatibility, and rigidity to changes in topology. The present invention provides algorithms and mechanisms that allow much of this complexity to be eliminated, by providing a single structure for addressing Nodes that is both scaleable and flexible.

Achieving scaleability, flexibility, or providing service addressing mechanisms, such as IP, requires complex mechanisms to direct data. A relatively large amount of processing must be performed at each Node, increasing the costs of both networking hardware and Nodes, and limiting the performance of the network. Using the addressing methods of this invention, lightweight routing mechanisms, such as a form of source routing, may be employed in order to dramatically reduce the amount of processing required at each Node. Moreover, the addressing mechanism disclosed allows for lightweight modifications of the basic routing to provide services such as QoS without a large processing overhead.

Networks are increasingly required to be adaptable to changes in their topology, such as when Nodes or sub-networks are mobile. This presents challenges that methods such as DHCP and mobile IP only partially address. Many of these schemes make extensive use of forwarding and proxies. Some methods, such as RIP, which transmits changes in topology between Nodes, present tremendous security hazards. Moreover, most of these methods have complex configuration issues that often require manual intervention. The addressing scheme of the present invention, and associated routing algorithms, provide for automatic and efficient adaptation to any changes in the topology of the network. This provides mechanisms for uninterrupted communication to and from mobile Nodes and sub-networks, as well as providing adaptability to network disruptions and modifications. The present invention also reduces the need for manual intervention, thereby reducing costs and increasing overall efficiency.

Most addressing schemes require a tight binding between the identifiers of source and destination Nodes, and their unique addresses. This, for example, means that in order to provide for replication of source data, some extra layers must be used. This increases network complexity and reduces efficiencies. It may require end-Nodes to agree on extra protocols, or it may rely on ad-hoc tricks, which may scale poorly. Since the addressing schemes and routing algorithms of this invention provide multiple addresses bound to identifiers, and because these assignments may be easily changed, this invention enables automatic caching, load balancing, and replication, at the network level.

A number of different technologies have been deployed that address some of these issues. However, none of these technologies provide a complete solution to all the problems solved by the present invention. Source Routing Bridges (SRBs) include in the frames the complete path data should follow, using the format Li, Bi, Lj, Bj, Lk, where Li and Bi identify LANs and bridges respectively. Each LAN connected to a bridge and each bridge connected to a LAN must have a unique identifier. SRBs assume that such identifiers are configured when the bridge or LAN is first created. The present invention, on the other hand, automatically generates new identifiers when Links and Nodes are added to or removed from the network, or are physically moved to a new location during operation. SRBs have to use broadcasting discovery frames to map destination addresses to routes. The present invention's destination labels are the route, and are locally established at Node attachment time. SRBs are discussed further in the following publications:

(1) R. Perlman, Interconnections: Bridges and Routers, Reading MA, Addison-Wesley, 1992.

(2) W. Stallings, Local and Metropolitan Area Networks, 4^{th} Ed, New York, Macmillan, 1993.

(3) A. S. Tanenbaum, Computer Networks, Systems.3^{rd} Ed., Prentice Hall, 1996.

The Dynamic Host Configuration Protocol (DHCP) is a solution to dynamically assign addresses to hosts. DHCP leases on demand Internet Protocol (IP) addresses from a directly connected server. Differing from the addresses in the present invention, IP addresses contain little routing information other than the network and host identifiers. The present invention assigns addresses through a fully distributed mechanism, whereas DHCP uses a centralized server. Furthermore, DHCP is designed to support mobility within a single administrative domain, usually a LAN, whereas the present invention supports global mobility. In addition, DHCP is designed for relatively long-lived leases from a specific server. In a mobile context, DHCP can work only if the original server is always accessible via a point-to-point connection (like a telephone call), which may not always be feasible. Finally, DHCP address generation is more complex than the address generation of the present invention. DHCP is described further in the following publication:

(1) R. Droms, “Dynamic Host Configuration Protocol,” IETF RFC 2131, Mar. 1997, available at http://www.ietf.org/rfc/rfc2131.txt.

Tag Switching (TS) and Multi-Protocol Label Switching (MPLS) use tags (or labels) associated with flows to improve switching performance. Tags have meaning only per Link, and have to be swapped at each intermediate Node using configuration information pre-stored in lookup tables. ATM networks use similar tags to identify virtual channels and paths. TS, MPLS and ATM have to map the destination address into the appropriate tag for routing at the network ingress Node, while the present invention's addresses already contain the route. In addition, tags require a table lookup at each intermediate Node, while the present invention's addresses already contain the routes. TS is further described in the following publications:

(1) Cisco, “Tag Switching: Uniting Routing and Switching for Scalable, High Performance Services,” white paper, available at http://www.cisco.com/warp/public/cc/cisco/mkt/ios/tag/tech/tagsw wp.htm

(2) B. Davie, P. Doolan, Y. Rekhter, Swithing in IP Networks IP Switching, Tag Switching, and Related Technologies, Morgan Kaufman Publishers, 1998.

(3) Y. Rekhter, B. Davie, D. Katz, E. Rosen, and G. e Swallow, “Tag Switching Architecture,” IETF Draft, IETF Network Working Group, available at http://www.cisco.com/warp/public/732/tag/tagsw_ov.htm.

(4) Y. Rekhter, B. Davie, D. Katz, E. Rosen, and G. e Swallow, “Cisco Systems' Tag Switching Architecture Overview,” IETF RFC 2105, February 1997, available at http://www.ietf.org/rfc/rfc2105.txt.

MPLS is further described in the following publications:

(1) R. Callon, P. Doolan, N. Feldman, A. Fredette, G. Swallow, and A. Viswanathan, “A Framework for MPLS,” IETF Draft, IETF Network Working Group, available at http://www.ietf.org/internet-drafts/draft-ietf-mpls-framework-05.txt.

(2) Eric C. Rosen, Arun Viswanathan, and Ros Callon, “Multiprotocol Label Switching Architecture,” IETF Draft, IETF Network Working Group, available at http://ietf.org/internetdrafts/draft-ietfmpls-arch-06.txt.

ATM is further described in the following publications:

(1) W. Stallings, ISDN and Broadband with Frame Relay and ATM, Englewood Cliffs, NJ, Prentice Hall, 1995.

(2) A. S. Tanenbaum, Computer Networks, Systems. 3^{rd} Ed., Prentice Hall, 1996.

Similar to the present invention, the Packetized Automatic Routing Integrated System (PARIS) and plaNET/Orbit projects use source routing to specify the labels of the Links data should follow. However, unlike the present invention, all source Nodes need to keep full topology information to compute the correct routes to a destination, which may not scale for large networks. PARIS is further described in the following publications:

(1) I. Cidon and I. S. Gopal, “Paris: An Approach to Integrated High-Speed Private Networks,” International Journal of Digital and Analogue Cabled Systems, Vol. 1., 1998, pp. 77-85.

(2) H. J. R. Dutton, “High Speed Networking Technology: An Introductory Survey,” IBM available at http://www.s390.ibm.com:80/bookmgr-cgi/bookmgr.cmd/BOOKS/EZ306400/COVER.

plaNET/Orbit is further detailed in the following publications:

(1) I. Cidon, I. S. Gopal, P. M. Gopal, R. Guerin, J. Janniello, and M. Kaplan, “The plaNET/ORBIT High Speed Network,” Journal on High Speed Networking 2, No. 3, pp. 171-208 (1993).

(2) H. J. R. Dutton, “High Speed Networking Technology: An Introductory Survey,” IBM available at http://www.s390.ibm.com:80/bookmgr-cgi/bookmgr.cmd/BOOKS/EZ306400/COVER.

Wormhole routing is an extension of the cut-through approach to switching data flows by avoiding the store-and-forward overheads. The first packet contains the routing information for the flow, commonly source routing. Wormhole routing resolves contention by blocking the incoming flow, while cut-through routing will buffer it. The present invention's switching is similar to source routing, and can apply wormhole or cut-though technology for improved performance. Wormhole routing is further described in the following publication:

(1) L. M. Ni and P. K. McKinley, “A Survey of Wormhole Routing Techniques in Directed Networks,” IEEE Computer, pp. 62-76, February 1993.

### SUMMARY OF THE INVENTION

In one embodiment of the present invention, a network is organized to provide dynamic allocation of multiple addresses per Node for the purpose of mobility and reliability. The present invention operates by viewing a network as a graph that is comprised of Links (corresponding to physical or virtual network Links) and Nodes (corresponding to network devices). The present invention performs the following labeling on this graph: (1) an origin is chosen, this origin can be a Node on the network, labeled as root Node R, or the origin can be a point that is not on the network; (2) each Node on the graph is assigned at least one coordinate label that indicates the position of the Node on the network relative to the previously chosen origin. One embodiment of the present invention generates the coordinate labels for each node by (1) assigning all Links one label such that no two Links adjacent to the same Node use the same label; (2) assigning each Node of the graph one or more labels which are concatenations of Link Labels for a possible path, without loops, to the root Node R. This is distinguishable from choosing a spanning tree, as in SBR, because all paths are available. Routing from one Node A to another Node B is accomplished by following one of the labels of A to R, and then following the reverse of B's label from R to B. Sometimes, more desirable routes can be identified when comparing the labels of A and B, as explained later.

DART dynamically assigns addresses to Nodes according to their relative location within the graph. When a Node joins or moves the network or a Link or Node fails, addresses are dynamically updated. If some Nodes are mobile (either mobile client Nodes or mobile server Nodes), the ability to route to and from the mobile Node persists. For example, a wireless server application such as a mobile sensor, mobile web server, or even a mobile telephone, is a networked Node that must be easily reachable even as it moves. Currently, it is often assumed that only an end Node may be mobile. However, as more networks become connected by wireless Links, the present invention will provide a solution that will allow the network to change dynamically. Link failures, caused by movements, or otherwise, can be similarly accommodated.

DART Nodes inherit their labels from their peer Nodes using several alternate algorithms. When two Nodes are connected by a Link, they negotiate a Link Label for that Link. Every Link directly connected to the same Node must have a distinct Link Label. For example, if Link Labels were positive integers, a Node could use the lowest positive integer not used on another Link by any of the other Nodes whose Links come into contact with that Node. In one embodiment a single Node is designated as the root Node. Although the graph is not required to be a tree, or have any particular structure, the labeling scheme maps a tree onto the graph. Unlike schemes that use spanning trees, many Nodes of the tree in the present invention may be mapped to the same Node. The root Node has a special label, ‘nil.’ All other Nodes begin without Node Labels. Only Nodes having at least one label can propagate a Node Label to another Node. The root begins by passing messages to its immediate neighbors indicating that its Node Label is ‘nil.’ To compute a label for itself, a Node maintains a list of all the labels its neighbors have sent to it. For each entry from a neighbor, a Node may create a new label for itself, by pre-pending the received label to the beginning of said entry. Each label obtained in such a manner may be interpreted as a path to the root Node.

With prior art addressing schemes, if the network contains many circuits, the number of labels a Node will have can be unmanageably large. The present invention provides only a finite number of labels per node. Labels are pruned internally to prevent circuits in the labeling. If a Node only notifies its neighbors of a fixed number of labels, the number of labels can be minimized, but at the cost of less optimal routing. As one example, we may choose for a Node to only pass the two shortest labels the Node has to its neighbor Nodes. We may use other criteria to determine which labels to propagate. For example, we may want to make sure that we pass labels that differ enough to make recovery easier if the Link associated with that label fails. We may use load, latency or reliability as inputs to our passing algorithm. Examples of algorithms for choosing labels to propagate are discussed below.

Changes in topology of the network, such as mobile Nodes, or Link failures, can be handled by short-term or long-term means. In the present invention, the address or Node Label reflects the location of a Node in the network. Thus, when a Node moves, the binding of a Node name to a Node address must change. This is the primary long-term method the present invention uses to adapt to changes in topology. The speed at which this change may occur depends on the speed at which the name resolution service distributes changes in its information. To provide short-term solutions for changes that are either temporary in nature, for example the interruption of a laser Link, or too rapid for the name resolution service, DART provides short-term forwarding services. Nodes that simply route do not require forwarding services. Only those Nodes which are the source or destination for a data stream may require such a service. Before a Node moves it will record the name of its immediate neighbors. Upon moving to a new location the Node contacts its former neighbors and passes on to them its new address in the network. Those neighbors may then forward messages that were destined for that Node. They do so until the name resolution device has had time to distribute information about the change. If the Link between A and B fails, A has a list of Node Labels for B and vice versa. Knowing Node Labels of A and B, the algorithm of the present invention provides a means to compute multiple paths from A to B. If a path exists that does not utilize the failed Link, it will be computable from the shared Node Labels. Thus A and B may provide forwarding services that modify the path of data trying to use the failed Link, by replacing the Link Label in the data with the alternative route. The data may then proceed normally. Again, as in forwarding, this need only continue until either the endpoints use the path information to redirect their data, the name resolution system catches up with the topology modification, or the failed Link recovers.

To provide scaleability, networks may be arranged hierarchically. Just as road systems are organized into highways, main roads and side roads, networks may be similarly multi-leveled. As a simple two-level example, the present invention permits top-level networks, called backbones, to connect smaller local networks of end-hosts together. Addresses can reserve some labels as separators. This permits a Node Label or path to comprise of a combination of Node Labels from logically distinct networks, each network having different root Nodes. To illustrate, consider several local networks. A first network with local Nodes A and B, which have coordinate labels with respect to a local root Node R. A second network has local Node C, which has a coordinate label with respect to local root Node S. The two networks are connected by a network backbone, which has a backbone Node T. When the name of a local Node A is stored in the name resolution device it is stored with the identifier of the local root R. When a Node B using the same local root resolves an address, it will match the identifier of the local root R and use simple route computation. When Node C, using a different local root Node that Nodes A and B. S) looks up the addresses of the Node B. Node C will get B's coordinates with respect to the root Node R. Node C will need to get the coordinates for root Node R with respect to root Node T. Node C will already know the coordinates of Node T) and its own coordinates, with respect to root Node S. Using these four sets of labels, Node C may now compute the shortest hierarchical route from C to B. Moreover, paths through the backbone may be implemented through local network paths as necessary. Just as in the Link repair mentioned above, a label or set of labels may be replaced during the transit of the frame, with a hierarchical segment that implements a virtual route through a local network route.

A network dynamically addressed, according to the present invention, may inter-operate with other network protocols through tunneling, translation services, or multiple protocol switches. As an illustration, if a network employing the present invention, and another network (either a separate network employing the present invention, or a network addressed using one of the prior art schemes discussed above) need to be Linked across the Internet, this may be accomplished by tunneling. First, suppose one Node in each local network is designated as a gateway for that network. These two Nodes may form a virtual Link using a UDP/IP or TCP/IP socket. Data entering this Node destined for the virtual Link will be wrapped in an IP packet at one end, sent across the Internet, and unwrapped at the other end. Similarly, an entire virtual network may be implemented this way. This may also be done directly with an Ethernet frame, where data is wrapped in Ethernet frames at one end, and unwrapped at the other, as may be done for ATM, MPLS, Appletalk, and other network protocols.

Second, data from a host using IP could be intercepted at a gateway Node. There the IP routing would indicate the IP address of the next hop. Assuming this next hop identified a Node on a network that employs the present invention, that IP data could be wrapped in a packet containing a path that is generated as described above, and the route to the next hop Node computed (or cached) by the gateway Node. When the packet is received at the other end, the IP data would then be unwrapped and the IP routing continued. This same mechanism could be implemented using Ethernet, ATM, MPLE, Appletalk, or any other network protocol.

Third, a Node may function as a gateway, translating addresses in one protocol to virtual addresses in the other. For example, if a network employing the present invention and an IP network were Linked, a gateway device between them could assign each End Node an IP address, and each IP address a virtual address. Data traversing through this Node is translated from one format to the other. Lastly, headers carry encoding unique to the present invention, and multi-protocol switches reading that part of the heading would switch the packet according to the method of routing specified by the present invention, rather than the other protocols it supports.

Mechanisms to provide services such as Quality of Service (QoS) guarantees, or encrypted channels, may be provided in a number of different manners. For example the header may contain a field that directly provides information as to the service required by the data. For example, to provide QoS, separate priority queues could be maintained for the differing levels of service. Another mechanism would allow switches to operate several distinct logical networks over the same physical network. Each logical network would have a network number, and a collection of services associated to it. Nodes maintain separate Link and Node Labels for each logical network, and each logical network may have its own root. Since paths are built from Node Labels, and end Nodes obtain Node Labels through the name resolution scheme, that scheme may be used to implement QoS. For example, end Nodes may only be given Node Labels that allow paths to be computed that implement a certain level of QoS, depending on the requirements of the end Node, data stream, or user.

Networks using the present invention can also provide broadcast and multicast transmissions via multiple mechanisms. One mechanism uses the above mentioned ability to provide multiple logical networks over the same physical network. End Nodes subscribe to a multicast by allowing their local switches to route to that network. Another mechanism allows for special Link Labels and grammar, which can provide for data to be replicated and sent out to multiple Links. Another mechanism may provide a number of services, such as broadcasting and multicasting, using the same kind of label translation used in forwarding, Link repair, and gateways joining other protocols.

The present invention provides mechanisms that may be used for clients to efficiently locate replicated data, as well as mechanisms to allow for the caching of data. For example, the label translation methods mentioned in regard to multicasting, as well as in forwarding, Link repair, and translating between other network protocols, may also be used to redirect a request to a cached versions of data. Also, since ordinarily the name resolver returns a list of labels even when there is a single Node bound to that name, a name may refer to several Nodes representing mirrors. For example “http://www.cs.columbia.edu/home/index.html” may be the name of several Nodes, each representing a mirror of the same data. When the name request is fulfilled, the labels returned may refer to more than one physical Node. The present invention's routing computations will automatically determine a path to the optimal Node.

Because the present invention permits dynamic labeling and re-labeling of a network, novel methods to provide security as well to implement “pay for service” options are possible. For example, by allowing Link Labels to be chosen from a large, even variable length space, and by re-labeling frequently, maintaining a valid path will require frequent access to the name resolution system. By limiting access, encrypting replies, and other means of controlling use of the name resolution, a network attacker's ability to route through a network may be curtailed and/or monitored. Similarly, it is possible to allow only Nodes conducting micro-payment transactions to access fresh Node Labels. Moreover, since the label structure only maps to the physical network, but does not actually reveal it, an attacker's ability to determine, and thus use, the network topology is limited.

Since data contain actual paths, Nodes maintain information about the network, such as Node Labels and local Link data. The name resolver service replicates and logs much of this information. A network management device given proper access may utilize this information to determine and fix network problems. The network management device may delete or restrict labels to reallocate loads. It may force the network to move a root Node, or split the network into a multi-level hierarchy. By utilizing the multiple network concept, new logical networks may be phased in and out without interrupting the flow of data.

### BRIEF DESCRIPTION OF THE DIAGRAMS

The following detailed description, given by way of example and not intended to limit the present invention solely thereto, will best be understood in conjunction with the accompanying drawings in which:

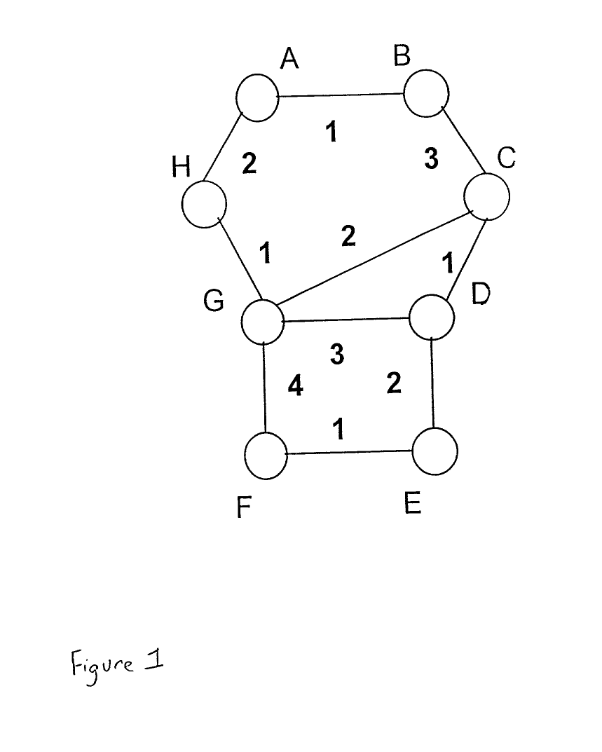

FIG. 1 shows an example of a typical prior end network for use with the present invention.

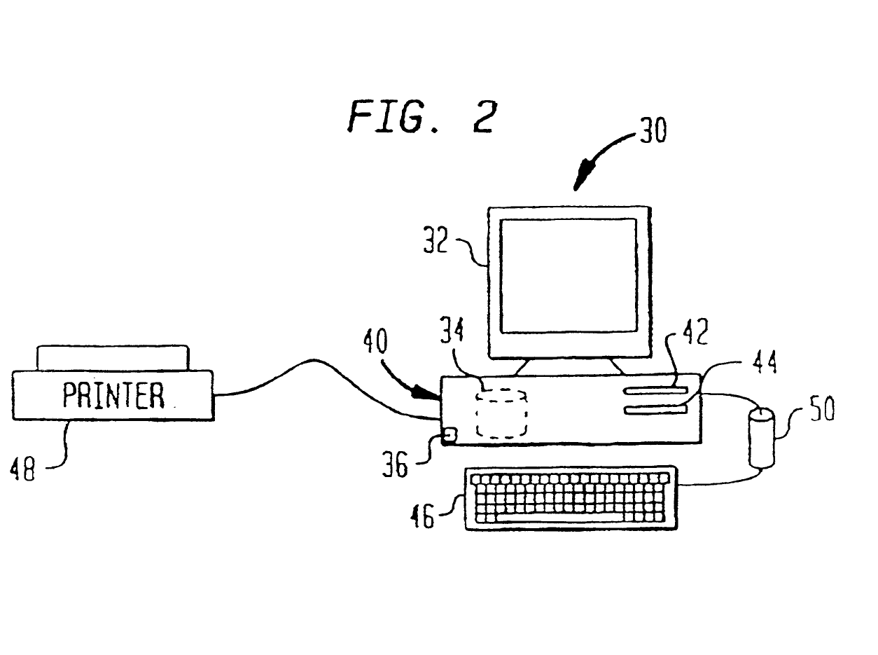

FIG. 2 shows an example of a typical prior end computer for use with the present invention.

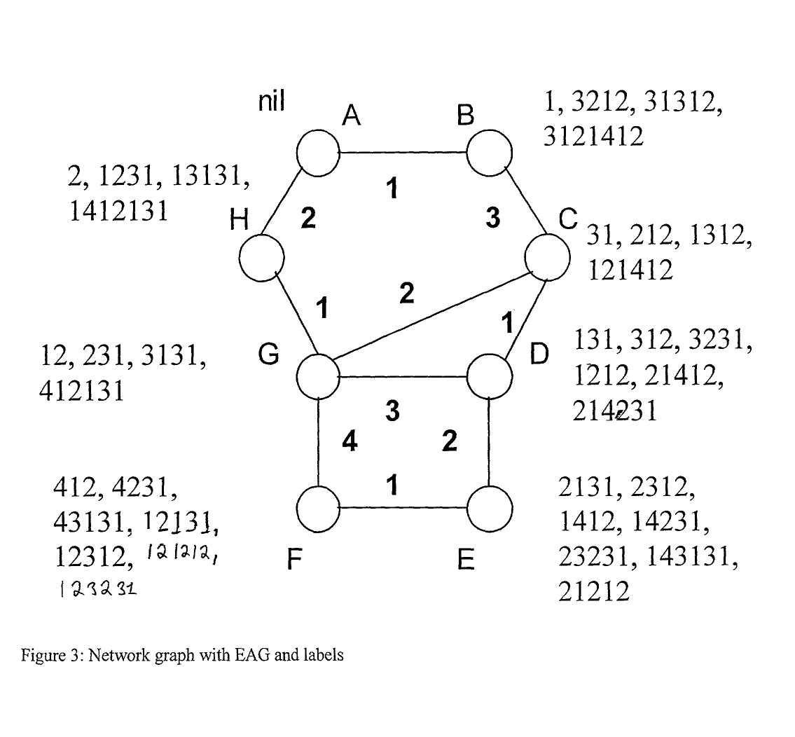

FIG. 3 shows an example of a network graph with EAG and labels.

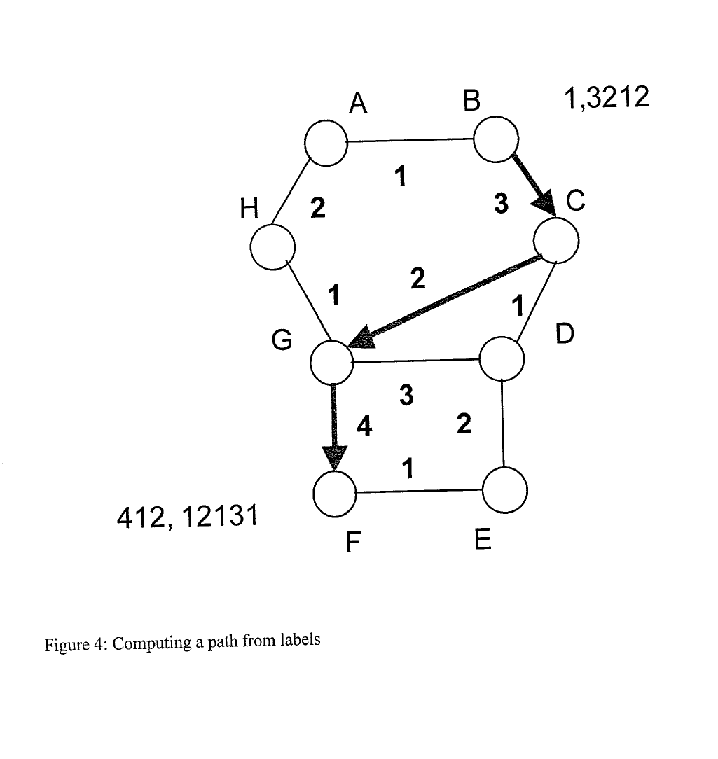

FIG. 4 shows an example of computing a path from labels.

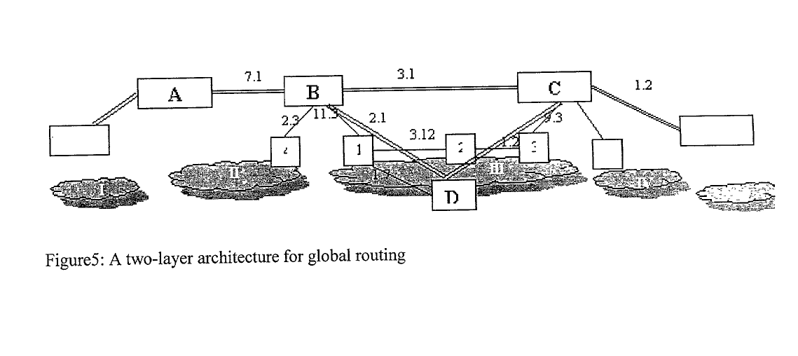

FIG. 5 shows an example of a two-layer architecture for global routing.

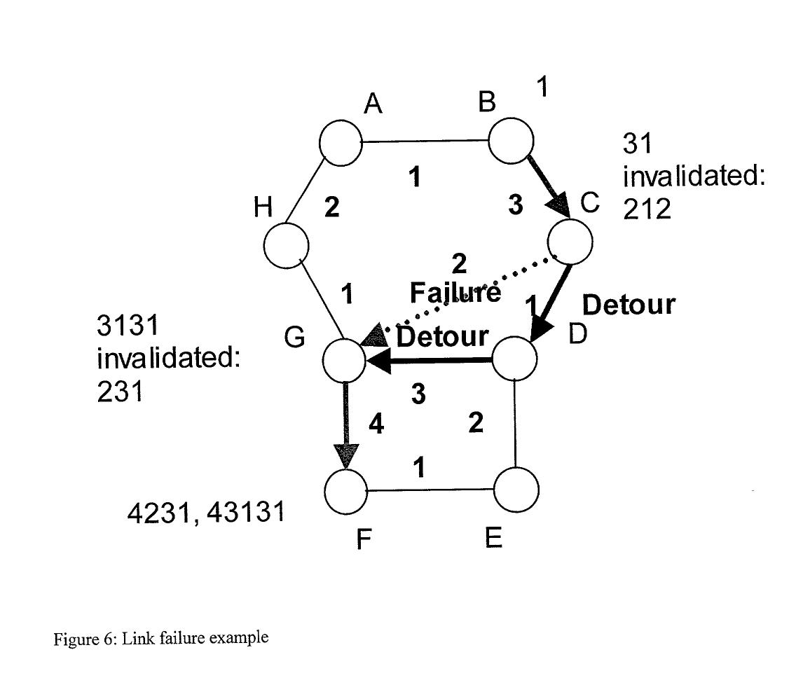

FIG. 6 shows an example of a Link failure.

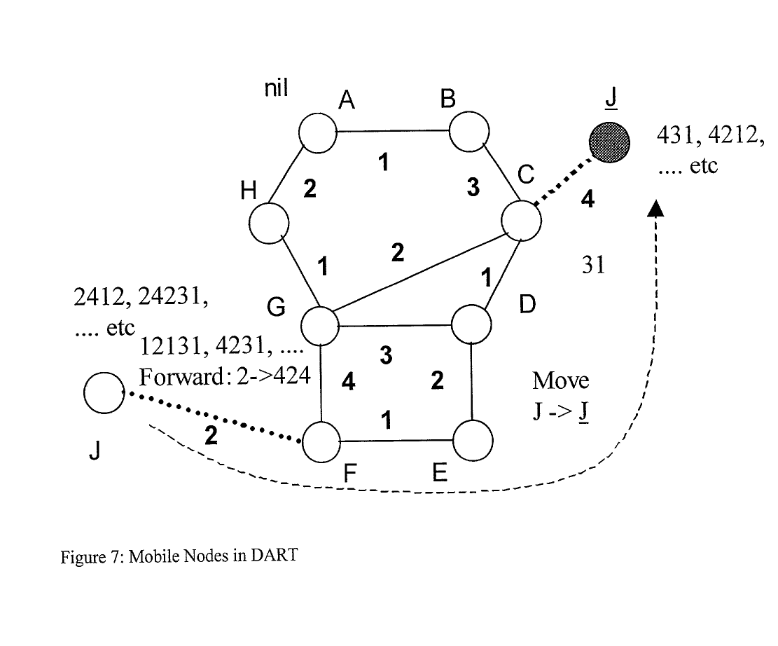

FIG. 7 shows an example of mobile Nodes in DART.

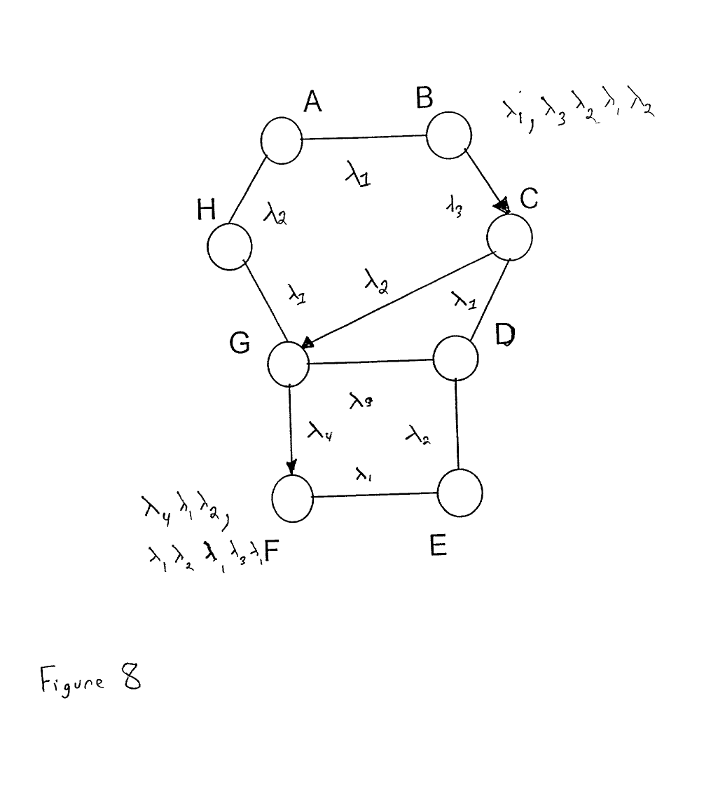

FIG. 8 shows an example of Wavelength Division Multiplexing.

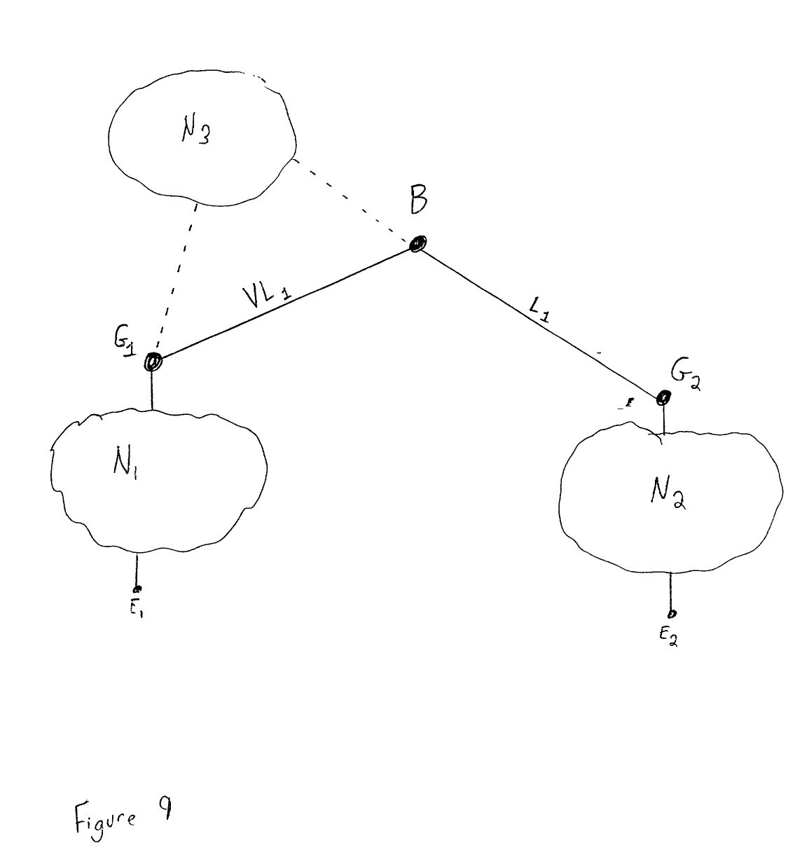

FIG. 9 shows an example of the use of Virtual Links.

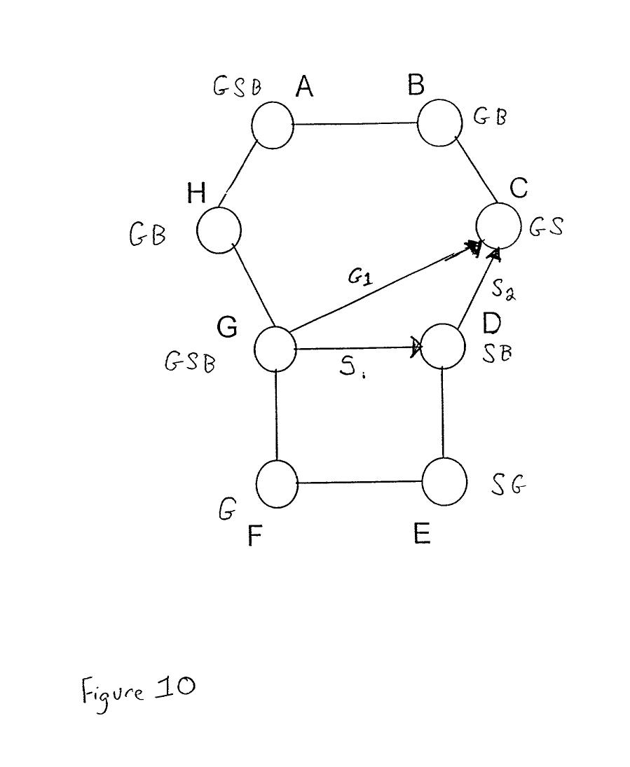

FIG. 10 shows an example of the implementation of Virtual Networks.

### DETAILED DESCRIPTION OF THE INVENTION

For purposes of this discussion, any structure (network, switch, Node, etc.) employing the present invention will be referred to as a DART structure. The present invention considers any persistent object/process in a network as an addressable unit (i.e., a Node) that can also be employed to function as a potential routing entity. A DART Node, like an IP Node, can be a network interface or a router/switch, but can also be a file, an application server (or replica), a cache, a web page, a process, etc.

The present invention provides a mechanism to compute an address for a Node based upon the topology of the network, and based upon the Node's local attachments to other Nodes. As a Node is added to, or moved, within a network, the present invention recalculates a new address for the Node based upon its new location. The method employed by the present invention permits a route between two Nodes to be computed and optimized entirely from the above calculated address information alone. Through the employment of the present invention, the movement of a file, web page, data, or other object is viewed as a special case of the replication or the creation of a new Node and can be re-addressed accordingly.

The present invention may operate in an environment as illustrated in FIG. 1, Nodes A, B, C, D, E, G, and H are interconnected by Links. These Links are labeled 1-4, with some Links receiving the same label, in accordance with the algorithm discussed below.

Illustratively, a Node may be a computer. FIG. 2 illustrates a conventional computer station, which includes a computer housing 40, a monitor 32 and a keyboard 46. Housing 40 comprises a modem jack or network interface 36, a hard drive 34, a floppy disk drive 42, a CD-ROM drive 44, and keyboard 46. Of course, a station may include additional or less hardware as desired. A printer 48 may also be included. However, as stated above, a Node is not limited to a computer and could be illustratively a file, an application server, a cache, a web page, etc.

First Embodiment

In one embodiment of the present invention, a labeled graph with a designated Root Node, also referred to herein as an Embedded Addressing Graph (EAG)), is used to assign network addresses to each Node. This network address takes the form of a coordinate label. This coordinate label indicates the position in the network of the node relative to a chosen origin. In this example, the chosen origin is the designated Root Node. The Root Node may be either an actual Node on the network, or a node that does not actually exist, i.e. an imaginary Node. The EAG is formed by creating a network graph where each Node is attached with a Link to all Nodes that support direct routing access to that Node. In one embodiment, coordinate labels for Nodes are generated by first having each Node assign labels to the Links of the network graph, that come into contact with that Node. Each cycle-free path leading from the root to a given Node will form a path label (otherwise referred to as a Node Label or coordinate label). In its most basic form, the address of a Node (i.e. it's coordinate label) is the set of its path labels. One skilled in the art would appreciate that it is possible to use multiple origins instead of the single origin discussed above. A simple translating mechanism can be used to allow data that is being routed according to from a Node that is labeled with a coordinate label relative to one root node, to be then routed from that root node to a second root node, and then finally routed onto a destination node that is labeled with coordinate labels relative to that second root node. The addressing scheme employed by the present invention can also be used to provide additional network services. These services will be discussed in detail below.

Second Embodiment

Another embodiment of the present invention supports the dynamic management of addresses. When a Node N attaches to a DART Node M, M will automatically assign one or more unique DART addresses to N. For purposes of the discussion of the fundamental addressing algorithms of the present invention, Links will be labeled with positive integers. However, for applications like name resolution or directory services, Links can be labeled with strings with external semantics. For example, Links can be labeled with a directory or file name. The addressing algorithms can also be extended to allow for the labels to be specified by distances or directions to support their use by a network of ships, planes or other mobile Nodes.

The assignment of labels to Nodes will now be discussed in further detail. In its most primitive form, DART uses EAG path labels to establish sufficient data at Nodes to compute best routes to their destinations. The process of computing path labels propagates in a completely distributed manner among Nodes, with each Node passing its labels to neighboring Nodes. The neighboring Nodes then compute their own path labels based upon the received labels. In the simplest case, labels are arbitrarily assigned to Links, for example, by using the next available label. This process is constrained by the rule that for each Node, every incident Link must be distinctly labeled. In regimes where Link Labels carry semantic meaning, the labeling is dictated by the semantic context. If directories are represented, then Links might represent containment, or other symbolic Linkage. For ships or planes, labels may be obtained by using the relative positions of the vehicles as measured by GPS.

FIG. 3 is a simple example of an EAG with Link and Node Labels. For purposes of this discussion, assume that Links have no semantic meaning. Neighboring Nodes can assign to a Link the lowest Link value that both of the Nodes have available. A, B, C, D, E, F, G, and H are Nodes. These Nodes are interconnected by Links that are labeled with Link Labels 1, 2, 3, 4 (with multiple Links assigned the same Link Label according to the rules discussed below). Labels of Nodes are formed by the concatenation of Link Labels. Neighbor Nodes exchange labels, and local Node Labels are constructed, by pre-pending the Link Label to a neighbor's Node Label. For example, Node H has the set of Node Labels “2, 1231, 13131, 1412131.” The creation of loops is avoided by discarding labels for which there is already a label present which is a suffix of the label to be discarded.

If the number of labels per Node becomes a problem, a Node can be instructed to exchange only the best labels (e.g., the shortest labels, or the labels with the lowest latency) with the Node's neighbors. If a graph has a large degree of connectivity, then the number of labels bound to each Node may explode. However, in practice, a typical IP network often involves a low degree of connectivity, and the number of distinct labels associated with a Node is usually manageable. Furthermore, at the application layer, access patterns are often centralized between a server process (e.g., a file server) and persistent objects and, thus, the number of labels is limited, too. Regardless, the present invention can limit the number of labels bound to a Node by filtering labels that are less likely to be used (e.g., long labels). Although, in theory, it is necessary to pass all labels to guarantee optimal routing, there are interesting heuristic approaches, which, though suboptimal, perform well. One example involves first selecting an integer k. Then have Nodes only pass k of their shortest labels to their neighbors (as measured by hop length or other metric).

The present invention accomplishes label assignment for a given Node, X according to the following Node-path labeling algorithm. All Nodes neighboring X pass their labels to X pre-pended by the Link Label connecting them, provided that the label does not already begin with that Link Label. For example, in FIG. 3, Node H would pass its Node Label “2” to Node G, pre-pended by the Link Label that it passes it's Node Label along, i.e. the Link labeled “1.” This results in Node G being assigned a Node Label of “12.” In another example, Node H could merely pass it's node label “2” to Node G, and Node G could then prepend the label with the link label “1.” However, Node H would not pass the Node Label “1231” to Node G, (resulting in a Node Label of “11231” after the link label is prepended by either Node), as Node Label “1231” begins with the same digit as the Link Label used to pass it (i.e. “1”).

X deletes all labels for which it has another label that is a suffix of that label. For example, Node C might pass to Node G the label “21312.” However, since Node C already has the label “12”, it would delete the received label “21312”, as both “21312” and “12” share a common suffix.

The above conditions prevent loops from being propagated throughout the network. Note that a Node Label, when read from left to right, is a route from the Node associated with that label to the root Node.

TABLE 1
Node names with corresponding sets of labels

| Node | |
|---|---|
| Identifier | |
| (name) | Node Label (which are also addresses to the root) |
| A | Nil (special root label) |
| B | 1, 3212, 31312, 3121412 |
| C | 31, 212, 1312, 121412 |
| D | 131, 312, 3231, 1212, 21412, 214231 |
| E | 2131, 2312, 1412, 14231, 23231, 143131, 21212 |
| F | 412, 4231, 43131, 12131, 12312, 121212, |
| | 123231 |
| G | 12, 231, 3131, 412131 |
| H | 2, 1231, 13131, 1412131 |

Third Embodiment

Another embodiment of the present invention provides for the routing of data. Node addresses are formed by concatenating at least two Link Labels. The routing of data between two Nodes is then accomplished by routing the data to follow the corresponding Link Labels. A DART Node can use its own address and the address of a destination Node to compute the set of all paths connecting them, and the corresponding respective path labels. A shortest distance path, relative to a given metric, can then be extracted from this set of paths. This shortest path can then be used to pursue source routing through DART switches.

Suppose Node H needs to send data to Node D. Node H must obtain some or all labels for Node D, or it may have these labels cached from a previous request. The following algorithm computes paths from Node Labels. First, a path from Node H to Node D is obtained by concatenating a Node Label for Node H with the reverse of a Node Label for Node D. Any suffix common to a Node Label of Nodes H and D should be removed from both before the labels are combined to compute the path. The shortest path, as computed by hop length or other metric, is then used to route the data.

For example, if FIG. 3, “1231” is a Node Label for Node H, and “131” is a Node Label for Node D. Removing the common suffix “31”, and combining the two Node Labels, yields the path “121.” Similarly, from the two sets of path labels, one can compute the possible paths “21323”, “2131”, “1412”, “121”, and “13”, and then select “13” as the shortest hop path.

The present invention can be used in a packet based or a circuit based network. In a circuit based network, once an End Node has computed a path between that End Node and another End Node, based upon the coordinate labels of the two End Nodes, the present invention can configure the network in such a way that all data sent between those two End Nodes will travel the same configured path, until an event, such as a movement, failure, or other network condition, necessitates the reconfigurement of the network. This is especially useful in MPLS, or in Wavelength Division Multiplexing, as discussed in greater detail below.

In a packet based network, once an End Node has computed the route to a destination, based upon the coordinate labels of the source and destination Nodes, it uses source routing to send DART Data with the respective path labels to guide DART switches. DART switches read the path labels and use these to forward the data to a respective outgoing port. Data is routed between Nodes according to the following algorithm: first a Node receives the data. Then the Node examines the current Link Label in the data's path label. The Node employs fast lookup to map current Link Labels to outgoing ports. The Node then advances the current path label in the data. Finally the data is sent out of the port.

For example, consider the routing path of FIG. 4. Nodes A, B, C, D, E, F, G, and H are interconnected by Links labeled 1, 2, 3, 4. Assume, as an example, that Dart Data is to be routed from Node B to Node F. A path, computed from a Node Label of B concatenated with a reverse of a Node Label of F, as discussed above, is computed and inserted into the header of the data. In this example the path “324” was generated. At Node B, the first digit of the path in the data is “3”, and so Node B advances the current Link Label pointed to in the data (i.e. sets a pointer to “2”), and sends the data out the port corresponding to the Link Label “3”. When the data arrives at C, the current digit of the Link Label is “2”. This continues, routing the data through Node G, until the current digit of the Link Label can no longer be increased, at which point the data has “arrived” at Node F.

Fourth Embodiment

Another embodiment of the present invention allows a DART network to operate hierarchically across multiple domains. IP networks distinguish the roles of edge vs. core routers/switches, and use different mechanisms to manage these roles. In particular, motion of flows among edge routers/switches is handled somewhat differently than the motions of flows at core routers/switches. Furthermore, IP networks organize the motions of such flows into a two-layer hierarchy. At the bottom layer of the hierarchy is the core routers/switches that move flows of data between hops. At the higher layer of the hierarchy, edge routers/switches route flows among them. In contrast, DART networks use identical mechanisms to handle edge and core Node functions and the motion of flows, and allow for the arbitrary hierarchical organization of such flow motions.

Consider a network that is further composed of other networks, as depicted in FIG. 5. FIG. 5 shows how routing can be organized into a two-layer hierarchy. This scheme can be easily generalized to function in a network that has more than two layers. In a two-layer hierarchy, the base (core) layer, e.g., Nodes 1, 2, and 3, supports the routing of flows between two Nodes of a given subnet. The higher layer is comprised of Edge Nodes interconnecting the networks (e.g., A, B, and C). Entire networks are treated by the present invention merely as Links connecting these higher layer Node devices. In the figure, the base layer Nodes are depicted by square boxes, and Links are depicted by single lines. The edge layer Nodes are depicted by rectangular boxes, and edge layer Links are depicted by double lines. In one example, Link Labels can use two bytes, and can be indicated by the notation x.y. For example, the base path from Nodes B to C, “11.3,3.12,1.2,9.3” (which is the concatenation of the labels of the links that form the paths between Nodes B and C) can be viewed as the equivalent higher level Link (labeled 3.1) that connects Nodes B to C.

Consider now a flow of data from network I to network V. Data arriving at Node B carries a two-layer path address of the form “2.3,3.1,1.2, . . . . ” The first label designates the last Link of the base-network path in network II, leading from Node A to Node B. This Link terminates at an edge-network router that reads the edge-network path label 3.1 and routes the data over the Link from B to C. The edge-network router removes 3.1 and inserts a new base network path that implements this BC edge-network Link, i.e., the data will carry the following new path route “11.3,3.12,1.2,9.3;1.2. . . ”This base-network router dispatches the data along the base network path 11.3,3.12,1.2,9.3 leading from B to the edge-router at C. When the data arrives at C, it will be routed along the edge layer Link 1.2.

Thus, DART facilitates layered networks by simply: (a) using multilayer route address structure, and (b) having higher layer routers support edge-function of replacing higher layer edge label with a lower layer path in the data's address. These mechanisms allow DART networks to support a hierarchy of virtual networks that admit simple and uniform layering and interconnections. Furthermore, unlike layering of virtual private network through tunnels and multiple encapsulation processing, DART headers admit multi-layer addressing.

How does a Node attach to the edge layer, and configure its routing functions accordingly? Consider the case when a new Node D wishes to join the edge layer network. It will need to attach to its neighboring edge layer Nodes, e.g., B and C. D proceeds by first attaching as a base-layer Node to its neighboring base-layer router Nodes. Once attached to the base network, it can compute the base routing path to B and C and pursue the attachment protocol to establish its edge-network connections to B and C. Once attached, the edge Nodes B, C and D can compute the base network paths that implement the respective edge layer Links. Notice that dynamic changes in the base network will automatically result in reassignment of base network paths to respective edge layer Links. Similarly, the present invention supports automatic adaptation to mobility and topology changes in the edge layer network. Overlaid layers are permitted to adapt to dynamic topology changes and mobility. In contrast, dynamic changes of topology in multi-layered IP networks can lead to complex configuration inconsistencies and failures.

Using multi-layer hierarchical encapsulation of addressing and routing permits the present invention to handle networks of arbitrary size. Uniformity of addressing and routing procedures at different layers permits the present invention to handle hierarchical organizations without substantial impact on DART Node architectures and allows the retention of simplicity of Node computations so as to accomplish low costs and high performance.

Fifth Embodiment

In another embodiment, the present invention can support QoS, or other similar parameters in two ways. The first method is to add a QoS tag to a path label, or the DART header, indicating the type of traffic/service requested. This is an obvious extension of similar existing mechanisms.

A second approach to QoS is to use Link types. That is, partition the label space of 64 k labels into segments associated with certain types of services. For example, one can designate all labels in the range 128.00-144.256 as Links oriented to supporting video traffic. This means that router Nodes establish a respective Link allocation mechanism that gives appropriate priorities to data flowing on such labels. An end Node wishing to route a video stream will route it over a path carrying such video Link tags. In other words, DART essentially forms a virtual video network by tagging Links as a video type, and configuring respective resource allocation mechanisms in Nodes to support such video flows.

The range of 128.00-144.256 would provide 4096 video Link Labels. These labels may be further partitioned to form various video networks. For example, partitioning 16 labels per network allows 256 different video networks. One of these networks may be used as a reservation-signaling network. Nodes wishing to send a video stream on one of the video networks can first use this reservation signaling network to reserve bandwidth on the network.

Link types may also be used to designate traffic security, or form Virtual Private Networks (VPN). For example, Links labels in the range 80.00-96.255 may be allocated to define various VPNs. A given VPN may be allocated Links marked 82.16-82.32. Among others, this means that Nodes seeking to attach to Links with these tags are authenticated by the respective DART router Nodes. Traffic on such VPN could be encrypted. Nodes and traffic on a given VPN could also be monitored to detect intrusion attacks. Note that the range 80.00-96.255 provides 4096 Link Labels. If a given VPN requires 16 labels, this scheme supports only 256 VPN. This may seem to be a constraint on the number of VPN supported by DART, but the hierarchical organization of DART permits multi-layer organization of VPNs. With just a two-layer hierarchy, the number of VPN increases to tens of thousands.

Link types may also be used to optimize route selection. For example, Links in the range *.192-*.200 may indicate high bandwidth or low priced Links, whereas *.183-*.191 may indicate medium bandwidth or high priced Links. An end Node selecting best routes can use these Link designations to evaluate the best route to a destination. Finally, Link types may be combined with the hierarchical organization of DART networks to support various combinations of services, such as secure voice networks. The present invention provides a mechanism for Nodes to coordinate their traffic-handling features by assigning flows to respective Link types.

Sixth Embodiment

The present invention also accommodates Node failures. Links are monitored by the respective Nodes attached to them. Upon the failure of a Link, a DART router Node uses the above described algorithms to update its path label addresses that depend on the failed Link, and then propagates these updated labels to all of the Node's neighbors. In the short term, while the DNS or equivalent is being updated to reflect the new location of a mobile Link, or the absence of a failed Link, a forwarding process can be activated. Arriving data that requires the use of a failed or moved Link are assigned a new path to their destination by the DART router Node. This new path is computed from the arriving data's routing path, and the respective path labels of the DART router Node.

The Link failure recovery algorithm is illustrated in FIG. 6. FIG. 6 shows a Network comprised of Nodes A, B, C, D, E, F, G, and H. These Nodes are connected by Links labeled 1, 2, 3, and 4. On failure of the Link Labeled 2, located between Nodes C and G, the forwarding process is activated. Node C will compute a detour path from Node C to Node G either using a label that has been passed from Node G (if enough were passed), from the DNS, or from another similar cache using the previous algorithm. For example, upon the failure of Link “2”, the new shortest path in FIG. 6 from Node C to Node G is now “13.” This path can be computed from the still valid label 31, and the still valid label from G, “3131.” The forwarding process on C is activated. All data, which C attempts to route to G via “2”, will have their paths modified so “2” is replaced by the forwarding process to 13; and will be treated as if they entered the switch with current label 1.

This forwarding procedure will persist until either the Link 2 is restored, or labels are propagated to reflect the topological change. A similar forwarding process will be activated on G. This ensures that a DART network will be robust with respect to failures.

In a typical scenario, when a Node attaches to a DART network it will establish Links to neighboring DART routing Nodes, which provide routing access functions. As part of this initial attachment protocol, the Node acquires its path labels from these routing Nodes and establishes its address. Once it has its set of labels, it uses DNS extensions to register itself in a DART name-address database. The new Node then propagates the new path labels to its neighbors. One proposed embodiment uses DNS and /or the Lightweight Directory Access Protocol (LDAP) for DART name-address resolution. One skilled in the art would appreciate that any other mechanism that stores a distributed database could be employed. The initial attachment protocol supports authentication of the Node's authorization to pursue such attachment. Data arriving during the process do not require any new processing, since the new Link is not yet reflected in their route. Thus, DART is self-configuring and requires no manual intervention.

As can be seen from the examples, DART propagates bad news in linear time and produces no looping or oscillatory behaviors as would be found in traditional distance vector routing. Good news, similarly, is propagated in linear time, and has no impact on transit traffic. The present invention handles a Node failure as a collection of Link failures at all attached Nodes.

Seventh Embodiment

Another embodiment of the present invention uses the dynamic allocation of addresses discussed above to support the use of mobile Nodes. The primary mechanism used to accommodate mobile Nodes is by automatically re-addressing the moved Node according to the above algorithm. While the network is waiting for the new node address to be re-calculated and made accessible, a mechanism similar to the above-described forwarding can also be employed by the present invention. A mobile Node can request its old attached routers to provide a forwarding service to its new address (reflecting its new location). This is done by computing the route from its old location to the new location, and by adding a redirection process bound to the old Link) that will forward any data in transit to the new location. In the case of a mobile routing Node, the neighboring router Nodes will provide both traffic forwarding services for traffic for which it is the ultimate destination, as well as adjust the path labels to reflect the loss of the respective routing Nodes.

For example, FIG. 7 shows a network composed of Nodes A, B, C, D, E, F, G, and H. These Nodes are interconnected by Links that are labeled 1, 2, 3, and 4. Suppose Node J is moved to a new location on the network, J. The Node F must first invalidate its Link 2, as this Link no longer connects to a valid Node. Node F will store or drop data addressed to travel along Link 2 until it receives instructions to begin its forwarding service. When the Node formerly known as Node J moves, and becomes Node J it can notify Node F of its new location. Node F then can compute a forwarding path; in this case it could combine its label “4231” with the J label “431” to obtain a forwarding path “424.” Data that was intended for Node J, can receive a new path to J from Node F, and can then be routed to Node J.

Eighth Embodiment

Another embodiment of the present invention allows DART networks to interact with other technologies, such as the Internet, Ethernet, ATM, MPLS, Appletalk, etc. DART supports interoperability with IP networks through multiple architectures and mechanisms. Networks using protocols other than DART may be used within the multi-level hierarchy mentioned above. It may also be that a DART network simply connected to a foreign network. There are three clear methods that may be used to communicate between foreign and DART networks. One way is simply to translate. For example, suppose a DART network is attached to an IP network at a single gateway Node. Each Node on a DART network is assigned an IP address. Each possible IP address may be given a designation via DART. When data arrives in either direction at the gateway Node it may be translated into a native packet of the other network. A DART network can be layered on top of an IP network, using IP Links to support DART Links. This means that DART data will be encapsulated within IP packets and tunneled by IP routers/switches between two DART routers/switches, and unwrapped at the other end. Similarly, an IP Link may be supported by a respective underlying DART path. This means that the IP packet will be encapsulated in a DART packet and transported by a DART network between respective IP routers/switches, and then unwrapped at the other end. In other embodiments of this invention instead of an IP network, the other technology network may be also be IP, Ethernet, ATM, MPLS, or any other foreign network.

Ninth Embodiment

The present invention supports the broadcasting and multicasting of data as an integral service. There are multiple alternate mechanisms that can support multicasting. One version is the use of overlaid multicast trees. First, a multicast tree subnet is created using the DART overlay mechanisms. Nodes can attach to this multicast subnet using the regular attachment protocol. A Node attaching to a multicast tree avoids creating a loop by attaching to a single router Node (its parent in the tree). Next, path routing labels instruct Nodes on the multicast network to broadcast data onto all outgoing Links. This is accomplished by designating special labels as directives to DART router/switch Nodes. This overlaid multicast tree accommodates the mobility of the underlying Nodes and topology changes. This is particularly important in mobile and ad-hoc networks. As the underlying topology changes, the multicast Links are automatically mapped to new underlying network paths. In another example, a single link label can be allocated with a special meaning. A reserved link label may be a signal to a switch to route data along multiple connecting Links. Multicasting may also be combined with QoS and security mechanisms through the Link types discussed in the previous section. These combinations of orthogonal constructs provide great flexibility and uniformity, while supporting a rich set of network services.

Tenth Embodiment

The present invention also supports the caching and replication of data. Most application level operations, such as transferring a file, viewing a web page, or sending or receiving e-mail, can be viewed as the equivalent to the replication or creation of a Node. The present invention supports several alternate mechanisms which can efficiently and automatically implement both caching and replication via Node replication. The present invention can implement replication or caching by first duplicating, and then moving a Node. This unified mechanism allows replication of servers, caching of frequently used data, creation of a shadow file server, load balancing, etc.

DART Nodes carry properties (or statistical data) that can be used to determine when to replicate the Node. When access to a Node or set of Nodes reaches a predetermined level, the DART replication mechanism locates, creates, and attaches a replicated copy of the Node, using several alternate heuristic algorithms. The replicated Node will be registered by the replicating Node with the name-resolution mechanism (if the replication access uses that mechanism) or with the redirecting proxy described below.

If caching is controlled by an intermediate Node (for example, the way most web browsers cache web objects once a statistical threshold is reached), the next access will cause the object to be copied, and pass the new parameters to a local Node. Then, depending on the mechanism, the object is registered for access. In the web browser example, one would most likely implement the browser as a proxy for a server Node, which then redirects requests for a static object to the cached objects.

The present invention employs multiple mechanisms for access and load balancing of replicas and cached Nodes. A first mechanism uses the fact that even without replication, name resolution typically yields several names (e.g. addresses) in the target namespace. This allows endpoints to compute optimal routes to Nodes. Replicated target labels (e.g. addresses) would be registered and maintained by the replicated Nodes, and thus have the same status as the alternate labels to the original data. When network latency properties are listed with the labels, then the same algorithms that an endpoint used to choose an optimal path now may yield an optimal route to a replica of the desired Node. If server Node load data is a property contained in a label, endpoints may use this information to choose server Nodes with the lowest load.

A second method for access and load balancing employs redirection. Data proxies of routing Nodes may filter requests for frequently accessed Nodes. The routing Node can then send these requests to end Nodes, which readdress them to replicas or cached copies. The benefit of this mechanism is that it is completely transparent to the end Node sending the data. This mechanism is analogous to, but much more flexible than, IP masquerading. The chief disadvantage over the above scheme is that there is a performance cost associated with the redirection. This method may be ideal for situations where replication is used to provide load balancing behind a proxy, which makes several Nodes (replicas) appear to be one Node. In such situations the time required to process the data overwhelms the overhead costs in redirecting them. Similarly in caching close to the client, described below, network latency overwhelms the overhead associated with redirection.

A third method for access and load balancing is for a request packet to travel to one Node, with that Node then forwarding the request to a replica or cached version, which responds to the request. Here, the same mechanism used for temporarily dealing with mobile Nodes (forwarding) is employed. Thus, as in the name-resolution mechanism, the basic framework of the present invention already enables access of replicas and caching, simply by extending the algorithm by which an end Node implements forwarding. The end Node can maintain statistics on its replicas, and use these to determine which replica should respond. This is analogous to the technology used by Akamai, which allows fragments of web pages to be stored on different servers, and changes tags in html based on the requesters location to retrieve the data from a nearest cache. The present invention is more flexible in that any sort of persistent object can be replicated in this way (rather then simply parts of web pages).

Eleventh Embodiment

Another embodiment of the present invention can be used to obfuscate locations within a network. Attackers to a network will often use knowledge of a network to attack it or gain unauthorized access. The method known as a “port scan” is where an attacker will check every known port on a list of IP addresses to see which services are available. Another weakness in IP is that addresses in a subnet are often assigned consecutively. Even if they are not assigned in order, the address space is small enough to be searched with a brute force scan. Security may be greatly increased if Nodes may be given addresses that are both far apart in address space, so they may not be searched or guessed, and these addresses changed frequently. If the coordinate labels of a Node are not known, then accessing these Nodes is nearly impossible. Obtaining the coordinate labels will require periodic use of the directory service that resolves names. By monitoring and restricting access to this service, knowledge of coordinate labels may be controlled and limited. In one embodiment of the present invention, fixed length Link Labels may be employed. If that length is chosen sufficiently large, there will be too many possible labels to search for the labels corresponding to active Links. Moreover, in another embodiment of the present invention employing lank labels of varying length, examining a path from a data header will not even indicate how many Links are traversed in this path. In this way the structure of the network may be obfuscated making it more difficult to attack.

Twelfth Embodiment

In another embodiment of the present invention a Dart network can support the use of Wave Length Division Multiplexing (WDM) to configure an optical network. WDM is one technique for sharing the bandwidth available at an optical Link. In WDM, wavelengths (or lambdas) are allocated in each Link. An end-to-end path is comprised of several lambdas, one per Link of the path, that are mapped from Link to Link at the optical switches. Lambda identifiers are thus DART labels in the optical domain, and are encoded using the method described above. An end node wishing to send data to another end node can generate a path between the nodes as described above. The network can then be configured according to that path. All data to be sent between End Nodes will be sent along the same configured path until an event occurs, such as a movement, failure, or other network occurrence that requires the network to be reconfigured. For example, FIG. 8 shows an illustrative network employing WDM. Nodes A, B, C, D, E, F, G, and H are interconnected by Links labeled λ₁, λ₂, λ₃, λ₄. Assume, as an example, that Dart Data is to be routed from Node B to Node F. A path, computed from a Node Label of B concatenated with a reverse of a Node Label of F, as discussed above, is computed. In this example the path “λ₃λ₂λ₄” was generated. DART will then configure the network such that all communications between Node B and Node F will use the above generated path.

Alternatively, one could send the labels coded in optics and have each optical switch convert the label to electronic form, and then employ traditional DART routing at each switch.

Thirteenth Embodiment

In another embodiment of the present invention, Link Label replacement is supported. In the simplest of schemes, a DART header has a path and a field, which is a pointer or counter indicating the part of the DART path already traversed. The only change to DART data as it is routed, is to advance this pointer. However, in more sophisticated schemes, part, or the entire path, may be modified by a router. For example, a Link Label “c” may be a virtual label not actually referring to any physical Link. Suppose DART data carries the path “abca.” Then the data arrives with indications to be routed across that Link “c”, a sequence of Links, for example “abbab” may be inserted into the path in place of “c.” The data would now carry the path “ababbaba.” In this illustration one symbol “c” was replaced by “abbab”. However, several symbols may be replaced by several other symbols. Label replacement is used in forwarding to a Node that has moved. Link Label replacement may also be used in routing around a failed Link, or it may be used to implement a path in a multi-level hierarchy of DART networks.

Fourteenth Embodiment

Another embodiment of the present invention maps generic names to DART addresses and vice versa. A Node in a network employing the present invention will generally have associated to it one or more identifiers. For example, if a Node is a web server, specified by a URL, it may have associated to it a name, such as “http://www.cs.columbia.edu/home/index.html.” If it is a phone number, it may have associated to it a name, such as “212-939-7000.” If it is a computer interface specified by an IP address it may have associated to it a name, such as “128.59.16.1.” A Node may have several names associated to it. The present invention uses a name resolution scheme to obtain a set of Node Labels (whose calculation is described in the above embodiments) from a name for that Node. For example, the present invention may store the name and a list of Node Labels in a Domain Name Server (DNS) database. That information can then be retrieved via the usual DNS methods, and protocols, for name resolution. When the name resolution is distributed as in DNS, the load of making queries to the database is distributed and replicated, to provide efficiency, scaleability, and robustness. When a reverse lookup is provided, a Node name associated to a Node may be translated into a phone number, IP address or URL. Such reverse lookups allow interoperability with prior set networks such as IP networks, or plain old telephone networks. Data, P, arriving at a gateway Node, B, may not explicitly contain a Node Label of the originating Node A. However, the header of P will contain a path from A to B. The Node B has access to its own labels, which may be interpreted as routes to the root Node. By concatenating labels of B to the path from A to B, a path from A to the root Node (i.e. a Node Label of A) may be computed. The reverse lookup may then obtain, for instance, an IP address for A, which can then be used by B to translate the data into an ordinary IP packet, to be sent out over the Internet.

Fifteenth Embodiment

In another embodiment of the present invention, link labels may be employed to identify a virtual link. As shown in FIG. 9, Local networks N1 and N2, having end Nodes N1 and N2 are connected to a backbone Node B through Gateway Nodes G1 and G2, respectively. In the above example E1, E2, G1, and G2 are considered to be a part of Networks N1 and N2. Nodes B and G2 are connected by a physical link as shown in the above embodiments. Nodes G1 and B are connected by virtual Link VL1. Virtual Link VL1 is in actuality a path through Local network N3. A single virtual identifier may be assigned to represent the entire path through network N3. End Nodes E1 and E2 will use this single virtual identifier in calculating paths between each other based upon their coordinate labels. Assuming End Node E1 wished to route data to E2, End Node E1 will use the virtual identifier, VL1. Gateway Node G1 will then use Link Label replacement to remove VL1 from the data's header, and substitute in the full path through N3.

Sixteenth Embodiment

In another embodiment of the present invention, a Node may hold coordinate labels that indicate the position of the node within multiple virtual networks that are implemented within the same physical network. In one embodiment Gold, Silver and Bronze level networks could be implemented within the same physical network. Each node that falls within some or all of these virtual networks will be assigned coordinate labels that belong to the respective virtual network. Additionally, some Links, such as more expensive links, higher security links, or higher bandwidth links may only exist, and be accessible, on some, but not all of the virtual networks. In FIG. 10, Nodes A though H, connected by Links, are assigned to Virtual Networks G, S, and B. Nodes A, B, C, E, F, and G, have been assigned to the G virtual network, and store a set of G coordinate labels. Nodes A, C, D, E, and G, have been assigned to the S virtual network, and store a set of S coordinate labels. Nods A, B, D, G, and H, have been assigned to the B virtual network, and store a set of B coordinate labels. Assume that Node G wishes to route data to Node C. Node G can route the data along either the G or S networks depending on its desire. If Node G wishes to route the data along the S network (which for example may be a less expensive network) It may route the data along S links S1, and S2. However, If Node G decides to use the G network (which could be a higher bandwidth, or a more expensive network) it can route the data along G Link G1.

Seventeenth Embodiment

In another embodiment, the present invention can be used to support MPLS explicit routing. An MPLS Node can establish an explicit route through an MPLS network, i.e. exactly which sequence of MPLS Switching Nodes and Links should be used for different types of traffic to reach each destination Node. Rather than each packet carrying the entire path, with all of the hops specified, the routing information is distributed into tables located in each switching Node; individual packets only need to carry an MPLS label. An MPLS Node can use the above-described invention to generate the paths between nodes. The present invention can also be used to select a “best path” from all possible paths (i.e. based on cost, bandwidth, QoS, security, etc.). After a path between two Nodes is calculated, or a best path selected from multiple calculated paths, this chosen path can then be used to create the tables maintained at each MPLS Switching Node.

As this invention may be embodied in several forms without departing from the spirit of essential characteristics thereof, the present embodiment is therefore illustrative and not restrictive, since the scope of the invention is defined by the appended claims rather than by the description proceeding them, and all changes that fall within metes and bounds thereof are therefore intended to be embraced by the claims.

We claim:

1. A network comprising a plurality of Nodes interconnected by Links, wherein:
(a) each Node is assigned a set of one or more coordinate labels, each representing a path comprising one or more Links or other Nodes;
(b) each coordinate label is unique to the Node to which it is assigned; and
(c) a path between a first Node and a second Node being determined from one of said coordinate labels associated with said first Node and one of said coordinate labels associated with said second Node.

2. The network of claim 1 where said coordinate label represents a path between said Node to which said coordinate label is assigned and a root Node.

3. The network of claim 1 where said coordinate label represents a path between said Node to which said coordinate label is assigned and at least one of a plurality of root Nodes.

4. The network of claim 1 where at least one of said plurality of No des is a computer file.

5. The network of claim 1 where at least one of said one or more Links is a directory access path.

6. The network of claim 1 where at least one of said plurality of Nodes is a computer process.

7. The network of claim 1 where at least one of said one or more Links is a directory access path.

8. The network of claim 1 where at least one of said Links is a virtual Link.

9. The network of claim 1 wherein each coordinate label representing a path comprises, in series, identifiers for Links and Nodes comprising said path.

10. The network of claim 1 wherein each of said set of one or more coordinate labels is periodically updated to reflect changes in said path.

11. The network of claim 1 wherein a Node identifier is indexed to at least one of said set of one or more coordinate labels, where said at least one of said set of one or more coordinate labels corresponds to at least one of said plurality of Nodes.

12. The network of claim 1 wherein said path is determined from said coordinate labels from said network and at least one coordinate label from at least one second network.

13. The network of claim 1 wherein at least one of said coordinate labels contains path information from said network and a second network.

14. The network of claim 13 where said path information from said second network indicates a backbone address.

15. The network of claim 1 wherein:
said first Node is a source Node; and
said second Node is a destination Node; and data is routed from said source Node
to said destination Node via said path.

16. The network of claim 15 wherein said data is routed to a plurality of destination Nodes.

17. The network of claim 15 wherein said second node is located on a second network.

18. The network of claim 17 wherein said data is routed through at least one third network in order to reach said destination node.

19. The network of claim 1 wherein a tree of routing paths is computed from at least one of said set of one or more coordinate labels.

20. The network of claim 19 wherein data is routed to at least one of said plurality of Nodes according to said tree of routing paths.

21. The network of claim 1 wherein a multi-cast tree is computed from a plurality of said set of one or more coordinate labels.

22. The network of claim 21 where data is routed to a plurality of said plurality of Nodes according to said multi-cast tree.

23. The network of claim 1 where said network is a ATM network.

24. The network of claim 1 where said network is a packet-based network.

25. The network of claim 1 where said set of one or more coordinate labels does not disclose information relating to a physical structure of said network.

26. The network of claim 1 where said set of one or more coordinate labels is further comprised of coordinate labels from a first virtual network, and coordinate labels from at least one second virtual network.

27. A method for determining a path from a source Node to a destination Node in a network comprising a plurality of Nodes interconnected by Links, said Nodes including a first Node, and a plurality of second Nodes, said second Nodes including said source Node and destination Node, said method comprising the steps of:
(a) assigning to each of said second Nodes, including said source Node and said destination Node, one or more coordinate labels, each coordinate label assigned to a second Node representing a path through said network from said second Node to said first Node; and
(b) determining a path from said source Node to said destination Node by combining one coordinate label of said source Node and one coordinate label of said destination Node.

28. The method of claim 27 wherein each coordinate label representing a path comprises, in series, identifiers for Links and Nodes comprising said path.

29. The method of claim 27 wherein each coordinate label representing a path is periodically updated to reflect changes in said path.

30. The method of claim 27 wherein said method comprises:
routing data from said source Node to said destination Node via said path between said source Node and said destination Node.

31. The method of claim 30 wherein said data is routed to a plurality of destination Nodes.

32. The method of claim 30 wherein said destination node is located on a second network.

33. The method of claim 32 wherein said data is routed through at least one third network in order to reach said destination node.

34. The method of claim 27 where said coordinate labels do not disclose information relating to a physical structure of said network.

35. The method of claim 27 where said coordinate labels do not disclose information relating to a physical structure of said network.

36. The method of claim 27 where said set of one or more coordinate labels is further comprised of coordinate labels from a first virtual network, and coordinate labels from at least one second virtual network.

37. The method of claim 27 wherein said path is determined from at least one coordinate label from said network and at least one coordinate label from at least one second network.

38. A Node for use in a network, said network comprising a plurality of Nodes connected by Links, wherein:
said Node for use in said network has one or more coordinate labels assigned thereto, each label representing a path from said Node to a particular other Node of said network, each of said labels being unique to said Node.

39. The Node of claim 38 wherein each coordinate label representing a path comprises, in series, addresses for Links and Nodes comprising said path.

40. The Node of claim 38 wherein each coordinate label representing a path is periodically updated to reflect a change in said path.

41. The Node of claim 38 wherein:
said Node routes data to a destination Node via a path determined by combining one of said labels of said Node and a label of said destination Node.

42. The Node of claim 41 wherein said packet is routed to a plurality of destination Nodes.

43. The Node of claim 38 where said coordinate labels do not disclose information relating to a physical structure of said network.

44. The Node of claim 38 where said set of one or more coordinate labels is further comprised of coordinate labels from a first virtual network, and coordinate labels from at least one second virtual network.
